(19) United States
(12) Patent Application Publication
(10) Pub. No.: US 2012/0290311 A1
(43) Pub. Date: Nov. 15, 2012

(54) Method and Apparatus for Physician Location Tracking

(76) Inventors: Saurabh Tara, Henderson, NV (US); Dhiraj Narula, Las Vegas, NV (US)

(21) Appl. No.: 13/269,432

(22) Filed: Oct. 7, 2011

Related U.S. Application Data
(63) Continuation-in-part of application No. 13/107,761, filed on May 13, 2011.

(51) Int. Cl. G06F 15/16; G06Q 50/24

(52) U.S. Cl. 705/2; 709/203

(57) ABSTRACT

A medical personal location tracking system provides efficient physician location reporting based on physician client device location. The medical communication system permits physicians to define location tracking control settings to control when and where the client device sends location data to a server and database. Subject to the location tracking control settings, the location tracking system provides location updates for the physicians so that requestors that wish to contact the physicians or know the location of one or more physicians can access the server to obtain location data. To obtain medical assistance to a medical emergency, an emergency alert may be generated and sent to physicians within a defined geographic area. Upon receipt by a physician, a physician may accept the emergency alert and travel to the medical emergency and be provided updates regarding the medical emergency. The person generating the emergency alert may track the location of accepting physicians.

### PRIORITY CLAIM

This application claims priority to and is a continuation in part of U.S. patent application Ser. No. 13/107,761 entitled Physician Regional Access Networking Agent, filed on May 13, 2011.

### BACKGROUND OF THE INVENTION

1. Field of the Invention

The invention relates generally to communications systems, and in particular a communications system for physicians and other medical professionals that provides efficient messaging for medical related communications to and from these professionals.

2. Related Art

The practice of medicine is evolving rapidly, and as the population ages, as science advances and new treatments become available, there is an increased demand for services. At the same time, we are now approaching the limits of society's ability to pay for these services, and provide service levels which meet patient expectations.

Other industries have been able to resolve some of these issues by increasing productivity, but medicine has been slow to deviate from existing practices. A number of innovations have occurred in delivery processes in other industries, resulting in a better customer experience at a lower cost while increasing productivity.

In order to adjust the cost-curve, different solutions have been proposed, some of which will probably achieve the opposite of their stated goal. The one area most people agree on, however, is that increased productivity of health care personnel, the most expensive part of a health care system, is an important component of reducing the cost of care.

Given the demographics of the population and the physician workforce, it is inevitable that physicians will be called on to see more patients and this can be done without limiting quality only by making their processes more efficient. The same is true for hospitals and for nurses.

For example, a newer model of efficient patient care is an exclusive hospitalist model where some insurance companies give exclusive contracts so that when a patient arrives at the hospital, the physician taking care of him/her is not their usual physician but a hospitalist whose function is to speed up the process of diagnosis, including obtaining the relevant specialty consults, necessary imaging tests, rapidly establish the plan of care, initiate treatment and discharge as soon as stabilized, for follow-up in the office with their regular physician. These exclusive contracts may also apply to specialty services. The goal is to achieve the same results in a shorter hospital stay, which patients like and is cost effective.

Though these care models improve efficiency while providing care to patients, they are most effective when communication between nurses and physicians, between hospitalists and specialists, and between hospitalists and the outpatient physicians and their staff is efficient. Traditional and other care models would also benefit from such communications efficiency.

From the discussion that follows, it will become apparent that the present invention addresses the deficiencies associated with the prior art while providing numerous additional advantages and benefits not contemplated or possible with prior art constructions.

### SUMMARY OF THE INVENTION

A medical communication system for providing efficient communication of medical information between physicians, other medical professionals, patients, and others is disclosed herein. The medical communication system enhances the flow of information to and from physicians and may provide tracking and/or recording services, such as for the purpose of keeping accurate and timely medical records. As will be set out further below, the medical communication system is highly beneficial to physicians who may be urgently needed urgently at times, and not urgently needed at other times and who are often sought after for medical advice through a volume of calls, messages, pages and the like. It is noted that dentists, nurses, psychologists, physician assistants, nurses, nurse practitioners, emergency medical technicians and other medical professionals may utilize the medical communication system herein. As such, the term physician as used in this specification and the claims that follow should be interpreted to mean any of these individuals or any medical personnel.

The medical communication system may have various configurations. For example, in one embodiment a medical communication system for communicating with one or more physicians may comprise one or more servers comprising one or more communications devices. The servers may be configured to present one or more physicians to a requestor through a first client device, and receive a contact request from a requestor through at least one of the communications devices. It is noted that the physicians may be presented in an order based on a status of the physicians. Such physician status may comprise an indicator of whether or not the physician is available for communication.

The contact request will typically include a physician identifier that identifies a selected physician from the physicians presented. The contact request may include a delay time and, if so, the servers may delay selection of the rule and delay contact with the selected physician according to the delay time.

A status of the selected physician and one or more contact preferences of the selected physician may be retrieved from one or more memory devices accessible to the servers using the physician identifier. The contact preferences may define one or more rules for contacting the selected physician through one or more communications devices. Each of the rules may define a contact number and a criteria that must be met before the contact number may be used to initiate communication with a physician.

The servers may select at least one of the rules based on at least a status of the selected physician. The selected physician may be contacted by initiating communication with at least one of the communication devices according to the at least one rule that was selected.

The servers may be configured to receive one or more status changes from the physicians via one or more client devices, and to update the status of the physicians with the status updates. In addition, the servers may receive a work schedule from the physicians, and to update the status of the physicians based on the work schedule. It is noted that the servers may be configured to receive the location of the physicians via one or more client devices carried by the physicians, and to select the at least one rule based on the location of the physicians.

In another exemplary embodiment, the medical communication system may comprise one or more servers configured to receive status information (indicating the availability of the physicians to respond to a contact request) from one or more physicians and store the status information in one or more memory devices, and present the physicians along with their status information to a requestor at a first client device.

It is noted that only physicians with status information indicating a current availability to respond to the contact request may be presented at the first client device. In addition or alternatively, the servers may be configured to receive one or more criteria for presenting the physicians at the first client device, and to not present one or more physicians not meeting the criteria at the first client device.

Similar to above, the servers may receive a contact request comprising a physician identifier identifying a selected physician from the physicians presented from a requestor, and retrieve one or more contact preferences of the selected physician from the memory devices using the physician identifier. The contact request may include an urgency indicator configured to identify the urgency of the contact request to the servers. The contact preferences may define one or more rules for contacting the selected physician through one or more communications devices.

The servers may then execute at least one of the rules to contact the selected physician by initiating communication with a communication device according to these rule(s). Communication with the communication device may be initiated by calling the selected physician and subsequently connecting the requestor to the call.

It is contemplated that executing a first of the rules may cause the servers to initiate communication with a first communication device, while executing a second of the rules causes the servers to initiate communication with a second communication device. The first and second communication device may be distinct. For example, the first communication device may be a pager and the second communication device may be a phone.

Various methods for efficient communication are disclosed herein as well. For instance, various methods for communicating with one or more physicians using a medical communication system are disclosed. Such a method may comprise sending at least identifying information for one or more physicians to a client device for display at the client device, and receiving a contact request comprising a physician identifier identifying a selected physician from the physicians from a requestor.

One or more contact preferences of the selected physician may be retrieved from one or more memory devices using the physician identifier. The contact preferences may define one or more rules for contacting the selected physician through one or more communications devices. The contact preferences may be received from a client device of the selected physician.

At least one of the rules may be selected based on at least a status of the selected physician. The status may indicate the availability of the selected physician to respond to the contact request. It is noted that a location of the selected physician may be received by the medical communication system, and the at least one rule may be selected based on the status of the selected physician and the location of the selected physician. An urgency indicator may be received along with the contact request as well, and the at least one rule may then be selected based on the status of the selected physician and the urgency of the contact request as identified by the urgency indicator.

Communication with at least one of the communication devices may then be initiated according to the at least one rule selected from the rules. It is noted that a delay time may be received from the requestor, and if so, initiating communication with at least one of the communications devices may be delayed according to the delay time.

It is contemplated that one or more substitute physician identifiers may be received from a physician. The substitute physician identifiers may identify one or more substitute physicians with which communication may be initiated. This allows substitute physicians to be contacted if the selected physician is not available. It is noted that a variety of personnel may be identified as a substitute for the physician for communication, such as physician assistants, nurses, nurse practitioners, receptionists, and other medical personnel.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a block diagram illustrating an exemplary medical communication system in an environment of use.

FIG. 1B is a block diagram of illustrating an exemplary mobile device.

FIG. 2 is a flow diagram illustrating operation of an exemplary medical communication system.

FIG. 3 is a block diagram illustrating communications capabilities of an exemplary medical communication system.

FIG. 4 is a flow diagram illustrating setup of physician information at an exemplary medical communication system.

FIG. 5 illustrates an example environment of use of the physician location system.

FIG. 6 illustrates an operation flow diagram of an example method of client device operation and system location tracking.

FIG. 7 illustrates an operational flow diagram of an example method of location data generation and upload.

FIG. 8 illustrates an example method of establishing an emergency alert and request for a responding physician.

FIG. 9 illustrates an exemplary latitude and longitude map for a geofenced location.

FIG. 10 illustrates an example method of geofence location analysis.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Unfortunately, there are many bathers limiting the speed of communication in medicine. Physicians are busy, often tied up with other patients, in surgery or in meetings. They may share coverage at hospitals with their partners for a few hours, for a particular day, on a regular or irregular schedule. They may be on vacation. For certain functions they may prefer that an assistant be contacted instead of themselves.

For this reason most physicians offer an office number. They have a staff member answer the phone and contact the physician or covering physician based on rules they have set up. After hours an answering service performs this function. A caller calls the physician number, gets transferred to an answering service, waits for an operator who takes the message, transcribes it to a pager and the caller awaits a callback, with no idea of how soon to expect a response. Either the caller has to call back if an answer is not received or the answering service may call back to check if an answer has been received and page the physician again.

Some physicians have developed workarounds to this problem. For instance, they may provide their cell phone number for patients to call directly, sometimes for an annual concierge fee (which is typically costly). Or they may provide their cell phone number to other physicians or to selected hospital departments. This has a disadvantage in that the number can get passed on to those who the physician may not wish to receive a call from. Also messages remain pending when the physician is in surgery, so the calling person has no feedback on whether the voice message was ever received. If the physician is on vacation, and still gets the call, the quality of vacation time is compromised and additional calls are needed to route the message to the covering physician. Some physicians have the answering service take the call and then call their cell phone, a tortuous workaround to protect the cell phone number.

Others use SMS text messaging to communicate with other physicians. Though this provides a reliable asynchronous method of communication, it has a particular disadvantage in that transmission of patient identifiers using a public network without encryption is a violation of HIPAA, the Health Insurance Portability and Accountability Act, rules on patient privacy. Hospitals will generally not allow their nurses to use their own cell phones to communicate with physicians in this fashion for this reason.

For hospitals, documentation of contact with physicians is an important part of the medical record. Unfortunately, with traditional processes, the nurse simply writes a note in the record stating the time of contact and the instructions thereof. This process can lead to errors and a he-said, she-said discussion after a sentinel event, which can limit the finding of an investigation and limit potential system improvements. Also, with current processes, there is no way to measure or track the speed and efficiency of response and how that might affect quality of care.

The medical communications system herein is configured to greatly improve the field of medical communications. In one or more embodiments, the medical communications system herein is directed to improving communications to and from physicians. As will be discussed further below, the medical communications system may leverage the near ubiquity of smart phone use by physicians. To illustrate, the medical communications system, may provide a constantly updated database of physicians in the regional network and their preferences on how they would like to be communicated with. Location sensing technology (such as GPS, cell phone triangulation, and/or location lookups based on IP address) may be used to identify physician location and instantly update communication preferences based on prior rules set by the physician.

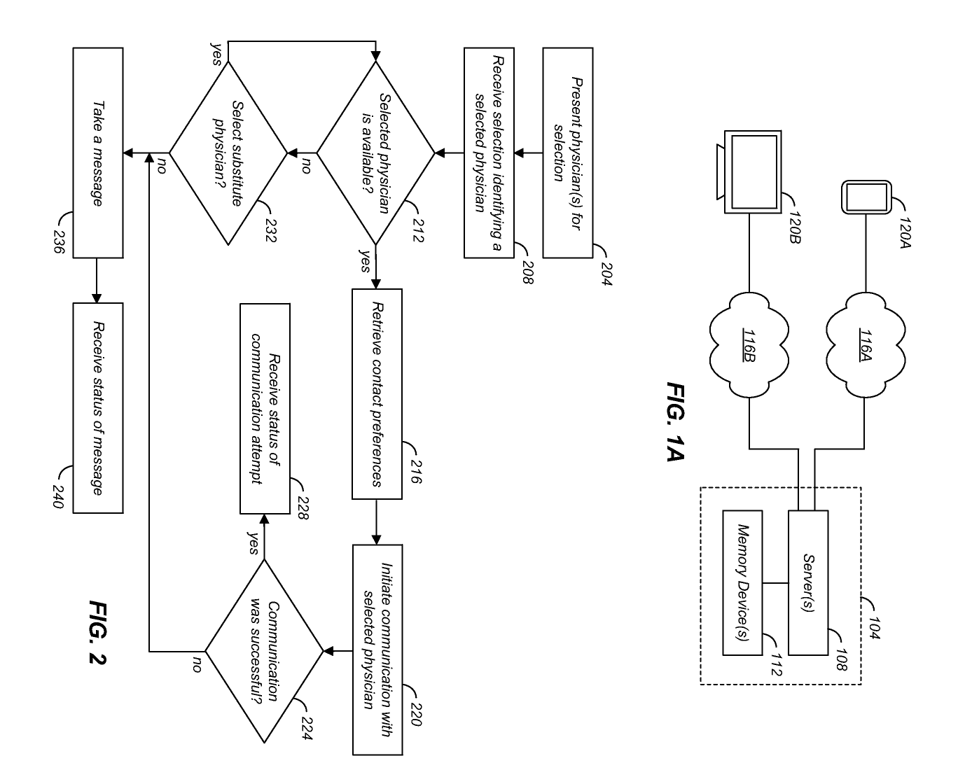

The medical communications system will now be described with regard to FIG. 1A. FIG. 1A is a block diagram illustrating an exemplary medical communication system 104 and components thereof. As can be seen, the medical communication system may comprise one or more servers 108. The servers 108 may comprise one or more processors, memory devices 112, and communication devices (such as network interfaces). In one or more embodiments, the servers 108 (such as via their processors and other components) may execute machine readable code stored on a machine readable medium, such as a physical memory device 112, to provide the functionality of the medical communication system as disclosed herein.

As can be seen, a memory device 112 may be a data storage device that may be external to the one or more servers 108. For example, a memory device 112 may be a remotely or network accessible storage device. A memory device 112 may also or alternatively be internal to the one or more servers 108. For example, a local storage device such as a hard drive may be internal to the one or more servers 108. The one or more memory devices 112 may also be various types of data storage devices. For example, a memory device 112 may be RAM, ROM, magnetic storage, optical storage, and/or flash storage in some embodiments. Other data storage technologies now known or later developed could also be memory devices 112.

Though illustrated as encompassing a server 108 and a memory device 112, it is noted that the medical communication system 104 may encompass various other hardware. For example, the medical communication system 104 could include various client devices 120,124 or other computing devices used to interact with the system. In addition, the medical communication system 104 may have components in geographically remote locations. For example, one or more servers 108 may be at different locations to service local populations and/or to improve redundancy, reliability, and speed/quality of service.

As can be seen, the medical communication system 104 may communicate with client devices 120 in various ways. In FIG. 1, the medical communication system 104 is shown communicating via various communication links. The communications links may transmit data through various networks to allow the medical communication system 104 to communicate with client devices in many different ways. For example, as shown in FIG. 1A, the medical communication system 104 is shown communicating via a cellular data network 116A, such as to one or more mobile client devices 120A, and via the internet 116B, such as to one or more desktop, laptop, or other client devices 120B. It is noted that communication of data is not limited to these examples and may occur through various communication links to a wide variety of client devices. For example, a laptop could communicate with the medical communication system 104 through a cellular data network 116A as well as the internet 116B, or via various other communication networks.

One or more client devices 120 (as described briefly above) may communicate with the medical communication system 104. In general, this communication will allow users to interact or use the medical communication system 104. The communication between client devices 120 and the medical communication system 104 may transfer messages, status information, graphical user interface (GUI) elements, or other data when the medical communication system 104 is in use, as will be discussed further below.

The client devices 120 may be portable and non-portable computing devices capable of allowing user interaction with the medical communication system 104. For instance, a client device 120 may be one having one or more input devices to accept user information or input, and one or more output devices to present information or data to the user. For example, in one embodiment, the client device 120 may have various buttons for input and one or more screens, displays, speakers or the like for output.

[0521 The client devices 120 may comprise one or more processors and memory devices. Like the servers 108 described above, the client devices 120 may execute machine readable code to provide the functionality disclosed herein. In one or more embodiments, the client devices 120 may download or retrieve at least some of the machine readable code from an external or remote storage device. For example, machine readable code could be downloaded to the client devices 120 from the one or more servers 108 and/or memory devices 112. For example, the machine readable code could comprise one or more web pages, or application software, or a request from web pages or an application which is transmitted or received from to the client devices 120. In one embodiment all or some of the communication between the client devices and the servers is encrypted.

FIG. 1B illustrates a block diagram of an exemplary client device. This is but one possible configuration and as such other client device configurations are possible. The client device 150 may comprise a smart phone, tablet, personal computer, laptop, pad type computing device, or any other client device capable of functioning as described herein.

As shown in FIG. 1B, the client device 150 includes an antenna 154 configured to send and receive wireless signals over a wireless network. The wireless signal may comprise computer network wireless signal, cellular data signals, or any other type of wireless transmissions. Although shown with an antenna it is contemplated that a wired connection (not shown) may exist.

The antenna 154 connects to a wireless communication device 158 which may comprise an analog front end in communication with an analog or digital baseband processing system. The wireless communication device 158 performs and oversees the wireless communication via the antenna. A processor 162 connects to the wireless communication module 164 and is configured to interface with the various components of the client device 150. The processor 162 is capable of executing machine readable code, for example software code, which is stored on a memory 164 or received from the wireless communication module 158. Any type of special purpose or general purpose processor may be utilized.

Also part of the client device 150 is a display 180 configured to present visual information to the user. Any type or size display 180 may be utilized. A user interface 176 is also present and capable of receiving user input. The user interface 176 may comprise buttons, keys, touch elements, dials, wheels, scroll balls or may be configured as part of the display 180, such as in the case of a touch screen.

A microphone 168 and speaker 172 also connect to the processor 162 as shown, which provide audio information to the user and capture audio information from the environment of operation and from the user. Any type microphone 168 having the capability described herein and speaker 324 may be utilized.

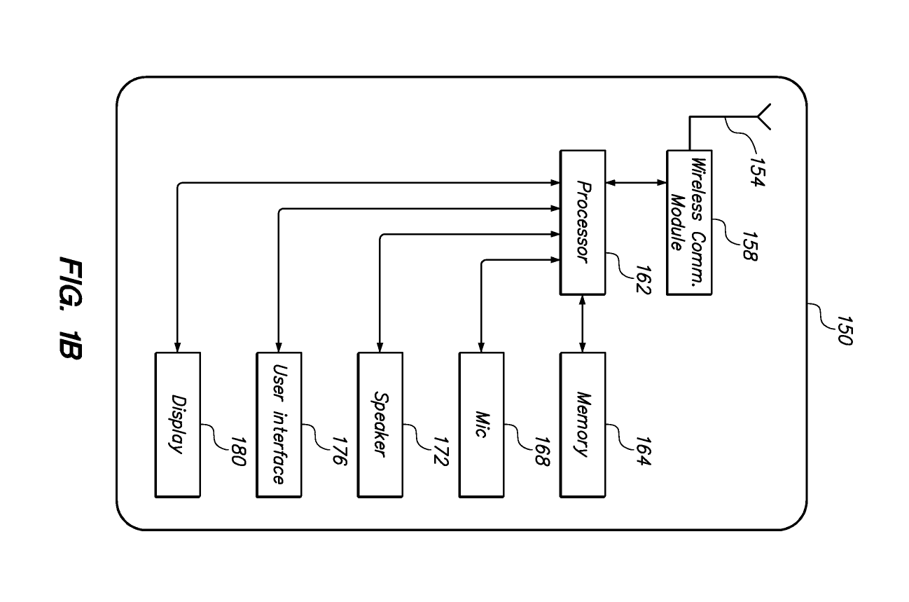

Aspects of the operation of the medical communication device will now be described with regard to FIG. 2. FIG. 2 is a flow diagram generally illustrating communication with one or more physicians. As can be seen, at a step 204, one or more physicians may be presented to a requestor. A requestor may be a user of the medical communication system that wishes to contact a physician. The requestor may be a medical professional or a patient for example, or any other party.

The list or other arrangement of physicians may be presented via a client device, such as on a screen of the client device and retrieved from a remote database, such as memory devices 112. The presentation may facilitate fast lookup of physicians based on various criteria. For example, physicians may be found by names, hospitals, geographic service areas, specialties, pictures, insurance accepted, descriptions and other characteristics. Physicians' schedules (which may be updated through the medical communication system) may also be presented. It is noted that this information may be presented as part of the presentation of physicians or may be hidden until a physician is selected or highlighted.

The physicians may be searchable in one or more embodiments. The requestor may browse, search, or review the list of physicians. Once a desired physician is found, the requestor may select that physician to contact. For example, the requestor may click on the physician to select the physician.

The medical communication system may take into account the physician's current location in some embodiments and/or the requestor's location in some embodiments. For example, a physician may be searchable based on their current location. This is highly advantageous in emergency or urgent situations, since the closest physician capable of treating a patient may be found and contacted quickly. In one embodiment, the requestor may be presented a listing of physicians based on their distance from the requestor's location. It is noted that the requestor may also or alternatively specify various locations. In this manner, the medical communication system may determine a physician's distance from a location other than the requestors and may be selected for communication based on that criterion. For example, if a physician is needed at a clinic or hospital other than the requestor' s this may be useful.

It is noted that various techniques may be used to determine a requestor's (or a physician's location). For example, GPS, cell phone triangulation, and IP address based location lookup could be used. In addition, a table or database of telephone numbers mapped to their respective physical locations may be used. For example, an outgoing number from a hospital, clinic, or other landline may be associated with its physical location. The location of calls or other messages from that number could then be determined based on caller id and the mapping between these numbers and physical locations.

At a step 208, the requestor's selection may be received. For example, a server may receive contact request information including an identifier from a client device. The identifier may be data which identify the physicians that have been selected. In some embodiments, multiple physicians may be selected. It is noted that the medical communication system may respond to a selection or “highlighting” of particular physicians by providing further information about the physician or about the physician. For example, contact information, practice information, schedules, languages spoke, or other information could be presented for a selected physician. It is contemplated that some or all this information could also be presented as part of the initial presentation of the physicians at step 204.

The contact request information may also include information regarding the contact request. For example, the location and/or identity of the requestor may be included. The urgency or type of issue (i.e., reason for contact) may also be provided. For example, urgency may be indicated by a numerical or other identifier where higher indicate increased urgency and lower values indicate decreased urgency, or vice versa. The urgency may be defined as a range of values from low or no urgency to high or maximum urgency.

The time of the request could also be included in the contact request. This information may be used to determine if a physician is available for such contact/communication, and also may be used to determine how to contact the physician according to the physician's preferences as will be discussed below.

At a decision step 212, it may be determined if the physician is available for receiving communications. There may be various rules or criteria that the medical communication system utilizes to determine the availability of a physician. A physician may be deemed available if his or her schedule indicates the physician is working or on call. A physician may have an associated status in some embodiments. The status may indicate whether the physician is working or on call for example. The status could also be other indicators. For example, the status may indicate that a physician is in surgery, on vacation, in a coverage arrangement or the like.

It is noted that the physician's status may be updated automatically by the medical communication system in some situations. For example, the physician may input his or her work schedule into the medical communication, such as via a client device in communication with the system's server(s). The medical communication system may then automatically indicate the physician's availability or unavailability based on a comparison between the current time and the work times specified in the physician's schedule. It is contemplated that the physician's schedule may be retrieved and viewed by various users of the medical communication system at various times. This is advantageous in that it leverages the up to date scheduling information captured by the medical communication system and allows it to be provided to various users (including physicians themselves) on client and other devices. Various rules established by the physician may control who may view the schedule and what aspects of the schedule are displayed.

In addition or alternatively, the medical communication system may receive status updates from physicians, such as via a client device belonging to or used by the physician. For example, a physician may update his or her status via a smart phone, PDA, laptop, or other computing device. Since these devices are portable, the physician may update his or her status from virtually anywhere. The physician could also send a message to the medical communication system to update status in other ways. For example, status updates could be sent by text message or through a call in number to the medical communication system. The status update may be a text string identifying the physician's current task in some embodiments. For example, the status update may be a sentence or other text, such as “In a meeting for the next 45 minutes” or just “In a meeting”. Other data such as identification of covering or substitution physicians/personnel may be provided in a status update. In addition, a physician may provide a schedule in a status update.

The current location of a physician may also be taken into account as part of the determination of decision step 212. This allows the physician's status to be automatically set based on his or her current location. For example, a physician that is at a particular hospital (or nearby) may be available at least to requestors at the same hospital. If a physician is too far away from where he or she is needed, the physician may be deemed unavailable. It is noted that the rules regarding availability based on the physician's current location may take into account the reason for contacting the physician. For example, if the physician is needed to by physically present (e.g., for surgery) then his or her availability may be based (entirely or partially) on his or her current location. This is especially so where the physician urgently needs to be physically present (e.g., for emergencies). If the physician is needed for a routine consultation, then his or her current location may have little or no effect on his or her availability as far as the medical communication system is concerned.

A variety of rules may be defined to identify particular locations or areas where a physician's status may be automatically set to available or unavailable. For instance, a hospital may be “geofenced” such as by defining an area including at least a portion of the hospital within which the status of physician's may be automatically set to some value. For example, if a physician is in the geofence around a hospital his or her status may be set to “Here Now” or available (at least to requestors at or near this hospital. Since physician specialties may be stored in the medical communication system, it would be possible to search for physicians having particular specialties within the hospital and rapidly contact such physicians. It is contemplated that the client device used by a physician may activate or deactivate particular features or functionality based on its location. For example, different features may be available on the client device depending on whether or not a physician is within or outside a geofence. The geofencing and automated status updates discussed above can be applied to multiple physicians or groups of physicians. As set forth herein one or more rules may control the geofence and status updates according to physician or system preferences.

The physician's location may be determined in various ways. For example, the physician may check-in with the medical communication system and provide his or her location in that manner. Alternatively or in addition, a mobile client device, such as a smart phone could detect the physician's location and report it to the medical communication system.

It is contemplated that the determination of a physician's availability may occur earlier in the processes in some embodiments. For example, the presentation of physicians at step 204 may involve determining which physicians are available. In this manner, only available physicians may be presented or may be presented before or more prominently than unavailable physicians. Alternatively, a physician's availability or unavailability may be presented during the presentation at step 204. A requestor may be permitted to input various criteria for determining availability of a physician, such as if the physical presence of a physician is required, as discussed above.

At the decision step 212, if the selected physician is available, one or more contact preferences may be retrieved for that physician. In general, the contact preferences define how and/or when a physician is to be reached. In one or more embodiments, a physician may input his or her own contact preferences into the medical communication system. These may be stored on a memory device for later retrieval.

For example, a physician may define one or more ways that the physician may be contacted synchronously or asynchronously. Synchronous communication may be two-way communication in real time. For example, a telephone call or videoconference. Asynchronous communication may be two-way communication as well but may be in less than real time. For example, asynchronous communication may be a text message, voicemail, fax or email where a response may come at a later time rather than immediately or nearly immediately.

The physician may provide cell phone numbers, landlines, fax numbers, pager numbers or other contact information that may be used to initiate asynchronous or synchronous communication. For example, a physician may specify that he or she be paged with a call back number for synchronous communication. As another example, a physician may provide a telephone number for synchronous communication. The physician may associate with each item of contact information (e.g., each phone number), when or how it may be used. For example, the physician may specify that a cell phone number may be used for emergencies or for particular requestors, while other requestors may only use a pager number, text message, or faxes to reach the physician. The physician may also specify that some requestors are routed to an assistant or office staff. The contact preferences may also specify one or more forwarding rules. For example, at particular periods of time, the physician may wish to forward calls or pages to particular numbers to other devices/numbers.

At a step 220, contact with the physician may be initiated based on the contact preferences. For example, if based on the nature of the contact request and the contact preferences, it is determined that the physician specified that he or she should be paged with a callback number, then the physician may be so paged with a callback number at step 220. If the contact preferences indicate the physician should be called, then a call may be placed by the medical communication system at step 220. It is contemplated that the medical communication system may function as an intermediary in one or more embodiments. For example, the medical communication system may call the physician and connect that call to the requestor. The same may occur for the other ways of communication specified by the physician. In this manner, the physician's telephone numbers and other contact information may be kept private.

In functioning as an intermediary, the medical communication system may mask/block or alter a caller id to preserve the privacy of a physician's telephone number. For example, in one embodiment, the caller id may be blocked. In another embodiment an alternate number may be presented as the caller id. In another embodiment, the medical communication system may forward calls placed to an alternate number to the physician's phone such as by maintaining a mapping database or table associating alternate numbers with physician phone numbers. In this manner, the physician's personal phone may be reached through an alternate number without releasing the physician's actual phone number. In another embodiment, in step 220, the communication system may relay instructions to call a number to the requestor's mobile device and block the display and/or later retrieval of the called number on the mobile device in order to keep the called physician's personal phone number private.

At a decision step 224, it may be determined if the physician was successfully contacted. For example, if a communications error occurred (e.g., no cell service), the contact may be deemed unsuccessful. This may be reported to the requestor so that the requestor may take steps to compensate. For example, the requestor may find another physician to contact if a failure to contact the physician is reported.

Asynchronous and synchronous communications may be deemed successful or unsuccessful in different ways due to their distinct characteristics. For example, a synchronous telephone call may be deemed unsuccessful if the physician does not answer the call, while an asynchronous text message may not be since the physician may take some time to read and respond to the text message.

In some embodiments, the physician's client device may present options for answering or responding to a contact request (e.g., a call, page, or text message). For example, if a call comes in, the physician may reject the call and provide an alternate method of communication, such as a page with callback number or text message. Likewise, if a text or page comes in the physician may respond and provide a phone number for voice communications, such as when an issue would be better discussed via a telephone conference.

If there was a failure to contact the physician, then the requestor may be notified of this failure at step 228. For instance, as discussed above, if a communication error occurs or the physician does not answer the phone the requestor may be so notified at step 228. It is noted that in some embodiments the requestor may be notified that contact failed after a period of time. This is to allow a physician a predefined period of time to read and respond. For example for pages or text messages the physician may be given a set period of time before the communication attempt is deemed unsuccessful and reported to the requestor as such. Different periods of time may be defined for different types of communications. For example, requests for asynchronous communication or urgent requests may have a shortened time period for a physician to respond before it is reported as a failure.

If contact fails or is unsuccessful, then the medical communication system may take a message at step 236. The message may be taken by the medical communication system itself or by forwarding or allowing a call to be forwarded to a voicemail or similar service. At a step 240, the medical communication system may receive a read receipt or other status notification regarding the message. For example, when the message is retrieved by a physician, such as via a client device, the client device may report this to the medical communication system. The medical communication system may in turn notify the requestor that the message has been received. This is beneficial in that the requestor receives feedback as to whether or not his or her message has been received, and may take further action based on this information rather than waiting around not knowing.

A message may also be forwarded in one or more embodiments. If a message is forwarded, the requestor may be provided a notification of this as well. This is beneficial because it allows a physician to send the message to an assistant or another physician who can handle the message and thus provide faster service to the requestor.

Messages may be presented to the physician via a client device. For example a list of message may be presented on a screen or display of a client device. This list may be sorted, such as based on urgency, requestor, time made or other criteria. Each message may be differentiated visually so that the physician may rapidly review the messages and decide in what order he or she will respond to the messages. In addition, the physician may see which of the messages have been responded to and which have not been.

It is noted that step 236 may not be performed when communication occurs via fax, text message, or the like since these communication methods would produce a message for later retrieval by a physician. In such cases, at step 240, the medical communication system may receive a notification that the message has been read or retrieved, such as described above. Also, like above, the medical communication system may report this information to the requestor.

Referring back to decision step 212, if the selected physician is not available, the system may determine if an alternate or substitute physician has been defined at a decision step 232. For example, a physician may specify, in his or her preferences, one or more other physicians that are in his or her practice group or that may cover for the physician. As shown in FIG. 2, the process may then return to decision step 212 where the availability of the substitute physician is determined

If the substitute physician is available then, he or she may be contacted as disclosed above. If the substitute physician is not available, another substitute physician may be selected from the originally selected physician's preferences, if any and the process may continue as indicated in FIG. 2 and described above. If no substitute physicians are available (or no substitute physicians are defined) a message for the originally selected physician may be taken at step 236.

It is noted that the physician's preferences may indicate different substitute physicians or no substitute physicians for particular situations. For example, the physician may setup preferences such that requestors from a particular location may contact a first group of substitute physicians, while a second group of substitute physicians may be contacted for requestors at other locations. To illustrate, the first group may include physicians at a first clinic or hospital while the second group includes physicians at a second clinic or hospital. In this manner, a patient or medical professional at one clinic may be put into contact with physicians who work at the same clinic or location.

One benefit of the medical communication system is the ability to track communications with physicians and to make a record of such communication, such as for auditing, patient records, or the like. For instance, a nurse or other requestor would not need to make a note or record when a physician is contacted since the medical communication system may automatically track communication attempts made to physicians. In addition, the requestor need not note the subject matter discussed. This is because the medical communication system may record the messages that are sent through it to physicians. For example, the medical communication system may be setup to initiate a call between a requestor and a physician and record the call to make a record of it. The call may then be entered into a patient's records, if appropriate.

As can be seen, the medical communication system may be used in this manner to reduce or eliminate written notes in charts by nurses, paging operators or the like. In addition, this eliminates errors that may occur due to communication problems between requestors and physicians. The medical communication system may keep records of messages received and responded to, including the contents of text and voice messages, or video in visual messages. The time of the message and response thereto may also be tracked. This permits a timeline for responses to be established and is useful in verifying when contact was made with a physician and when a response was made by the physician. This is also useful in analyzing response times, establishing best practices, and identifying outliers for counseling such as physicians that do not respond to urgent messages. It is noted that the client device used by the requestor and the physician may be configured to allow a note (voice, text, video, or otherwise) to be attached to a message for inclusion into medical records. A notification may be sent to inform parties (e.g., the requestor or the physician) that a note has been made.

Another benefit of the medical communication system is the speed at which appropriate physicians may be found and contacted. Though described in multiple steps above, it is noted that from a user's perspective, the process of contacting a physician may be as easy as clicking on a physician or selecting a physician from a list. The medical communication system may automatically determine the best way to contact the selected physician (based on the physician's preferences, location, nature/urgency of the contact request, etc. . . . ) and proceed accordingly automatically.

In addition, the medical communication system collects up to date information regarding schedules, status, and contact information. This is because physicians may input updates to the medical communication system through a variety of mobile and non-mobile client devices. In this manner, the physician may change his or her status, update his or her schedule, and even change contact information from virtually anywhere and at any time. This is highly advantageous especially in unique situations. For example, if a physician loses or breaks his or her cell phone an alternate number may be quickly provided to the medical communication system. For instance, the physician may borrow a client device (e.g., a smart phone) or find a nearby client device (e.g., desktop computer) to update contact, status, or preference information at the medical communication system.

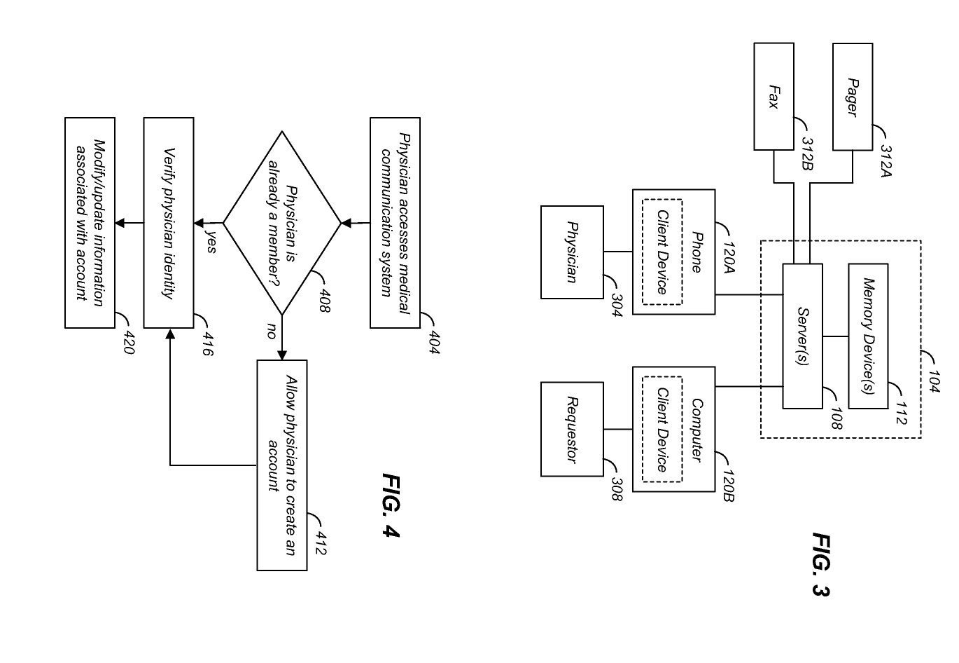

FIG. 3 is a block diagram illustrating communications between various devices when the medical communication system is in operation. As can be seen, the medical communication system 104 may communicate with various client devices 120 and various communications devices 312 when in operation. In the exemplary embodiment shown, the medical communication system 104 has communication links 116 with a smart phone 120A which functions also as a client device and a phone, and a client device in the form of a computer 120B. The medical communication system 104 also communicates with messaging devices, such as the fax machine 312B or pager 312A shown. It is noted that the medical communication system 104 may communicate with more than one of these devices. It is noted that a variety of communication links 116 may be used to effectuate communication. For example, a phone line (or the like) may be used to send faxes while a data link may be used to send text messages.

As shown in the example of FIG. 3, though a variety of client devices may be used, the physician 304 is using the smart phone 120A while the requestor 308 is using a computer 120B. In operation, the requestor 308 may select the physician via the computer 120B and as a result communication may be initiated with the physician 304, such as described above with regard to FIG. 2.

As can be seen, the medical communication system 104 may contact the physician 304 through its communication links with messaging devices or client devices. As discussed briefly above, the medical communication system 104 may function as a hub or intermediary through which communications may occur in some embodiments. For instance, if the physician preferences and availability indicate a phone call to the physician is in order, the medical communication system 104 may establish the call to the physician 304 and connect the requestor 308 to that call so that two-way communication may occur between the physician and requestor. The medical communication system 104 may, but need not, remain part of the call such as to record the conversation, forward the call to another physician or party, or to include additional physicians or parties in the call. It is noted that the physician's status may be updated to reflect that he or she is in a call in one or more embodiments.

If the physician preferences indicate contact should be made or initiated via pager or fax, then the medical communication system 104 may send a page or fax to a pager 312A or fax machine 312B specified by the physician, such as in the physician's contact preferences. The content of the page or fax may be obtained from the requestor via the client computer 120B, such as by sending a call back number or a document from the computer to the medical communication system 104. Alternatively, the medical communication system 104 may provide a fax in number or a paging number. The requestor may then fax or page this number with a fax machine, telephone, or other device. The fax or paging number may be a number that the medical communication system 104 provides. In this manner, communications by fax or page may be tracked and recorded automatically. The fax or page may then be forwarded by the medical communication system 104 to the physician's pager 312A or fax machine 312B. It is noted that in some embodiments, the fax or paging number may be that of the physician's pager 312A or fax machine 312B so direct communication may occur with these messaging devices.

The ability to function as a communications hub is also beneficial in that it permits delayed messaging. For example, a requestor may specify a delay time that must pass before a contact request or message (such as a text message for example) is sent to a physician. This is beneficial to avoid sending contact requests or messages at inconvenient times, such as the dead of night, which may not need to be sent at those times. In addition, since the requestor may input a delayed contact request or message in the medical communication system at any time, the likelihood the requestor will forget to pass along the request or message is greatly reduced, if not eliminated. A delayed contact request or message may be initiated by inputting a time or delay period with the request or message, such as at a client device used by a requestor.

It is noted that a physician may also specify delays in his or her contact preferences. For example, for incoming contact requests or messages of low urgency or of particular types, the physician may specify that they are delayed until he or she has a working status (e.g., is scheduled to work). Alternatively, these requests or other communications may be delayed until a reasonable time (or any other time desired by a physician), such as the next morning.

In one or more embodiments, the medical communication system may translate or convert one type of communications to another to allow the physician to more easily receive and read messages. For example, a message by fax may be converted to an image and sent to the physician's client device 102A, such as his or her smart phone. In this manner, the physician 304 does not have to go to a fax machine or pick up the fax to view its content, especially if the client device is a mobile device.

The same capability may work in reverse. For example, a physician 304 may fax documents such as prescriptions from his or her client device 102A. This allows physicians to issue prescriptions from virtually anywhere. It is contemplated that paper documents may be sent in this manner as well. For example, the client device 120A may be used to scan or photograph documents which may then be faxed to various numbers by first transmitting the scan or photograph to the medical communication system 104.

Some communication requests may request that a physician call a particular number. Physicians may be reluctant to do so with their personal phones since their caller id may give away their personal home or cell phone number. Rather than forcing physicians to carry multiple phones, the medical communication system 104 may use its communications hub capabilities to allow physicians to call requestors back without revealing their phone numbers. For example, a phone call from the physician may occur through the medical communication system 104 which may change or mask the physician's caller id such that a business phone or no phone number is shown. This may occur by the physician calling the medical communication system 104 and the medical communication system routing the call to the call back number. Alternatively, the physician may communicate two-way audio via a data connection with the medical communication system 104 and the medical communication system may patch in a call to the requestor with a selected caller id or no caller id.

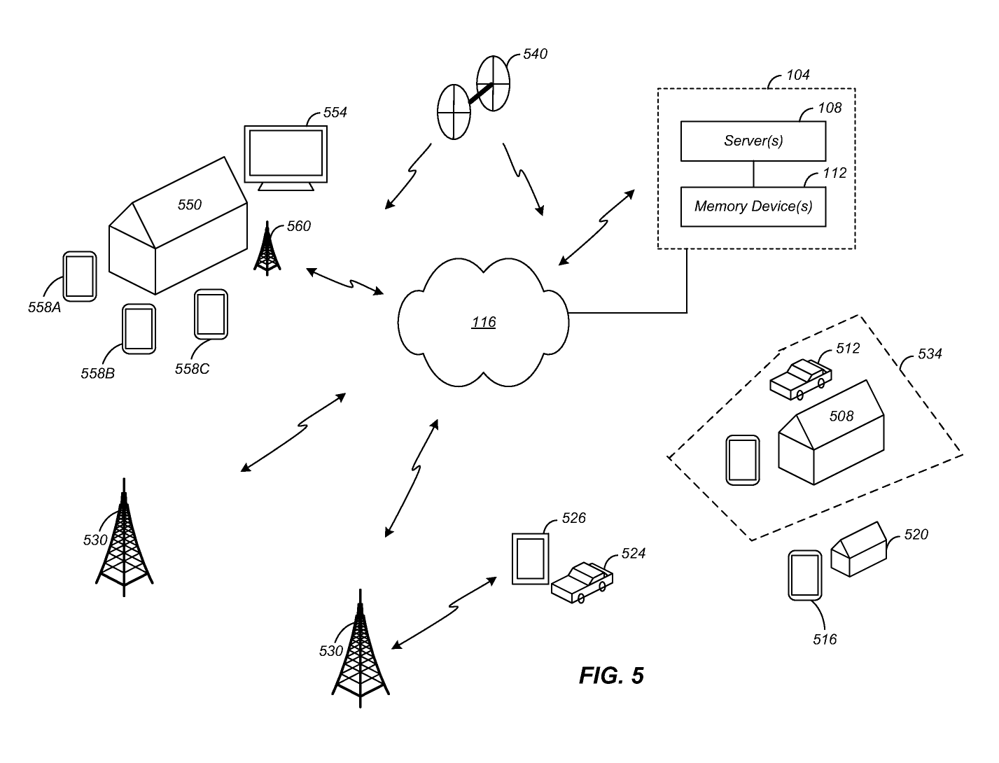

FIG. 4 is a flow diagram illustrating an exemplary process through which the medical communication system may accept information to allow physicians to participate in (i.e., join and use) the system. As shown, at a step 404, a physician may access the medical communication system. As described above, this may occur by the physician accessing a server of the medical communication system via a client device.

At a decision step 408 it may be determined if the physician is currently a “member” (i.e., already has a valid account) of the medical communication system. If not, the physician may be prompted or required to create one before he or she may make further use of the system. At a step 412, the physician may create an account. Typically, this will involve the physician inputting identifying information, such as name, address, phone number, license information, or the like. Account creation may also collect billing information so that the physician may be charged for using the medical communication system. A picture of the physician may also be inputted. The physician may use various input devices (e.g., keyboard, mouse, touch screen, camera) of a client device to input this information. The client device may send this information to a medical communication system server where it may be stored for subsequent retrieval.

The account information may be stored separately from other information the physician inputs. In this manner, the physician may, but need not, define various contact preferences, contact numbers, and other contact methods that are separate or different from the account information. For example, personal numbers, addresses, and account numbers may be used to create an account and for billing purposes and contacting the physician with regard to the services offered by the medical communication system. Other contact information could then be used in the physician's preferences. The physician's private or personal information may be kept so in this manner.

Once the physician has an account, he or she may verify his or her identity with the medical communication system at a step 416. For example, the physician may verify his or her identity by logging in to the system with a username and password and/or other identifying information. It is contemplated that a physician may be permitted to input identifying information for other users, such as the physician's assistant(s), that may also access the physician's account, with various privileges.

At a step 420, the physician may setup or modify various aspects of his or her account. New information and modifications may be saved by a server and memory device of the medical communication system. For example, the physician may input one or more contact numbers, such as phone numbers, fax numbers, and pager numbers. The physician may also input one or more contact preferences. These may come in the form of rules. For example, the rule may be to call number X between time Y1 and Y2, but page number Z or take a message outside of that time window. As can be seen, a variety of contact rules may be defined. The rules may also take into account the nature or urgency of a contact request. For example, call number X any time in life or death situations, emergencies, or for other urgent matters. Also, as discussed above, the rules may take into account a location, such as the requestor's location. For example, page number Z or take a message if requestor is requesting contact from clinic A, but call number X if requestor is at clinic B.

The contact preferences may include rules to contact other physicians. For example, if unavailable attempt contact with physicians 1, 2, and 3 (or any other number of physicians. It is noted that the physician may define different groups of physicians for use with the same or different rules.

The physician may also update or create a schedule by inputting his or her schedule information or updates into the medical communication system. For example, the physician may define a 5-day work schedule of various hours by inputting the same into the system. The physician may then create or adjust contact preference to take his or her schedule into account. For example, take a message if not scheduled to work, but call number X if scheduled to work or on call.

It is noted that the medical communication system may automatically update a physician's status based on the schedule if desired. For example, the physician's status may be changed to unavailable or on vacation or in surgery based on information indicating the same in his or her schedule. As stated, the physician may also update this information such as via his or her client device. For example, once logged in, the physician may manually set his or her status as appropriate. This would typically override the physician's current status.

In embodiments, where it is possible to receive a physician's location, it is contemplated that the physician may be permitted to activate or deactivate location tracking and save this information as part of his or her account information. In addition, the physician may define contact preferences based on his or her location (in addition or instead of the requestor's location as discussed above). For example, call number X if I am at hospital 1, but page number Z if I am not.

The examples of contact preference rules above illustrate the versatility of the medical communication system. It is noted that the contact preferences may include a variety of rules having a variety of criteria. For example, time, status, physician location, request/requestor location, contact type, urgency, availability of substitute physicians, and other criteria could all be used in one rule, or a subset of these and other criteria may for a contact preference rule.

Knowing the location of users of the communication system adds additional functionality to benefit physicians, other users of the communication system, hospital personnel, and patients. Knowledge about the location of a physician is important for numerous reasons. By way of example, when a doctor or hospital is seeking a specialist or an internist to take care of a patient, one of the most important facts that can influence the decision regarding which physician to select is availability.

Unfortunately, physician availability is not systematically available for referring doctors. In the past, availability was sometimes inferred from an assigned call list that might indicate that a first cardiologist is assigned to be available to take care of patients admitted with heart problems through the emergency room at a particular hospital. Alternatively, the referring physician may learn which other specialists are available by calling an answering service number that might indicate that a second cardiologist is assigned to be taking calls for Doctors A, B, C, D, E, F and G for the period 5 pm today to 7 am tomorrow.

The question remains though about the location of the first and second cardiologist. The cardiologist could be physically in the hospital, at home awaiting a call, or in surgery at another hospital. An answer to this question is very important to maintain an efficient hospital and for referring physicians, who just admitted a patient with a non-critical cardiac condition at a particular hospital and needs the advice of a cardiologist. If the referring physician asks the first physician in the prior art method described above, and the first physician is in surgery at another hospital, then the patient might only be seen the next day as sicker patients would take precedence. If the referring physician or hospital knew that a third physician was physically present at the same hospital when he needed the advice, the referring physician may contact this third physician to see the patient immediately, to the greater satisfaction of the patient and family, and the timely advice might have allowed an earlier diagnosis, a speedier resolution of the condition, and an earlier discharge and a lower cost of care.

Using prior art methods, the referring physician does not have the time to call six different answering service numbers to ask if someone is available now (and the answering service might not know the assigned schedule of the physician in any case. Plus, the referring physician is certainly not going to page six doctors in sequence to find out who is available. The only way the hospital or referring physician will know that the third physician is in the same hospital is to physically see him or run into him in the corridor or the physician's lounge. To reduce the costs to the hospital and patient and to improve medical outcomes, a better way of physician location tracking is disclosed herein.

Physicians also enjoy benefits from the communication system. As can be appreciated, availability is one of the most important attributes that let a physician grow his/her practice. Ability and affability are also important, but availability is key. A specialist starting a practice is often advised to make it a point to be seen on the hospital floors when the primary physicians make rounds in the evening after office time. While this prior art method of meeting new primary physicians and obtaining referrals is functional, it is very inefficient.

There are also situations that arise when a specialist with the necessary skills is needed immediately to help with a critically ill patient, when every minute matters. One example might be a patient whose heart suddenly slows down to 20 beats a minute or stops. For this event, a first responding emergency physician needs to be located and notified immediately. If the first responding physician is unable to return the heart to normal activity, such as with medications or external electrical stimuli, then a specialist may be needed, such as a cardiologist to insert a pacemaker wire. Or a patient undergoing a routine procedure may have a complication, be bleeding, and a thoracic surgeon is needed right away. In the prior art, a first physician is assigned to be available on the ER schedule, and can be there in 30 minutes. In certain situations, 30 minutes is too long of a delay. However, a second physician meeting the specialist requirements may be physically in the hospital for rounds or other reasons, but no one associated with the emergency knows he is there. The hospital is large, and the lack of information can make the difference between life and death, or determine the length and severity of the hospital stay.

In health care, where a team approach with specialists is critical, a more efficient and advanced system and method for physician tracking is needed. No individual can have all the knowledge or skill to solve all medical needs. This is why the team approach has become more prevalent. For a team approach to be successfully enabled, knowing the location of the team members is critical. For example, to take care of a patient with a heart attack, a team needs to be activated: a cardiologist, a cardiac catheter lab technician, a nurse, a radiology technician. And all need to come in as soon as possible because time is of the essence.

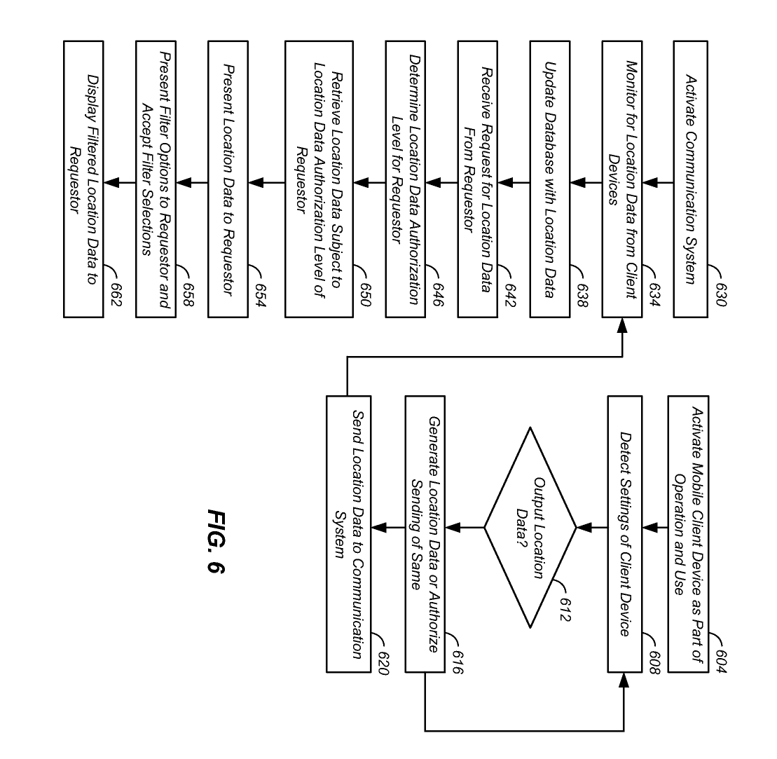

FIG. 5 illustrates an example environment of use of the physician location system described herein. The physician location system may be used for location tracking, communication, and collaboration. It provides an intelligent physician network. While the system is shown in this example environment of use, it is contemplated that it may find use in any environment whether limited to a particular site or building, a rural area or a crowded city. More or fewer components may be used with the communication system and client devices.

In this example embodiment, the environment is a city having multiple buildings, vehicles, and cellular communication and network towers. As discussed above, the communication system 104 includes one or more servers 108 and memory devices 112. Client devices 516, 558 are also part of the communication system 104. The client devices 516, 558 communicate with the communication system 104 over a communication network 116 which may comprise a cellular network and hardwired network, collectively referred to as the Internet and private networks, or WIFI, internet, intranet, or any wireless network data system. The communication system 104 communicates with the other elements of the system over the network 116.

To achieve location tracking, the one or more client devices 516, 558 include location tracking capability. The term client device is defined herein to mean the physical client device hardware in connection the software executing on the client device. The client device 516, 558 is contemplated to be a mobile device or fixed device. The software comprises machine readable code stored on a physical memory. The location tracking capability may comprise one or more of the following: global positioning system capability, latitude and longitude reader, network location tracking, communication tower triangulation or cell tower identification, user input, third party location services (such as but limited to Location Labs, located in Emeryville, Calif., 94608, or schedule based tracking. In addition, direction tracking is also available. These features are discussed below in greater detail. Using these forms of location tracking or others as developed in the future, the location of the client device 120 may be determined at the client device, or location data may be uploaded to the communication system 104 and the location of the client device may be determined at the communication system. Using location data, the server 108 updates a database stored on the memory 112 as to the location of each client device subject to the settings of the client device.

The database may perform location data translation, look-up operations, or both to convert the different types of location data from the client device to location data which can be utilized by the communication system and other client devices. For example, GPS location data may require a first type processing while network location data may require a second type processing to accurately determine location in relation to a map or other format. It is also contemplated that the location data may be superimposed or correlated on map data at the server and that the memory may store or download one or more maps for this purpose.

By way of example, a client device 526 may be carried by a user while walking or in an automobile 526 or any other mode of transportation. Using any mode of location sensing discussed below, the location of the client device 526 may be determined and tracked.

### Global Positioning System

One method to determine and track the location of the client device is using a global positioning system having one or more satellites 540 or other location monitors (not shown). A GPS receiver and processor with associated software (machine readable code) may be built into each client device 516, 558. By using GPS, the location of the client device may be tracked. Numerous smartphones and other devices include GPS and this system is widely available across North America. While GPS tracking provides high accuracy, its signals are received from high altitude orbit satellites and as such the signals are weak and unable to penetrate thick forests, tunnels and many buildings.

### Network Location Tracking

Another method for location tracking is network based location tracking. This method of operation utilizes network data information to determine the location of the data network to which the client device is connected. As is understood, modern communication devices such as client devices may connect to either the cellular network or a computer network via hardwired connected or a wireless connection (Wi-Fi). With either connection the network connection may be analyzed and the location of the network may be determined Based on this location data, the location of the client device may be determined. In one embodiment, the communication system maintains a list of computer networks which are part of the communication system and the corresponding physical location for each network. In other embodiments, other means of determining the location of a computer network may be enabled. If the client device is connected to a particular computer network it can be inferred that the client device, and hence the physician is at that location or within the range of the computer network. In one embodiment, each network is provided with an identification number or code. This data may be used to identify the location of the wireless network. In one embodiment a look-up occurs into a database or catalog of network locations.

It is also contemplated that a building or hospital may install or use location tracking devices within certain locations to provide greater resolution. For example, the surgery areas may have location sensing devices installed which provide or receive signals from the client devices to thereby indicate that the client device, and hence the physician is in surgery. These devices are referred to herein a secondary location sensors or secondary location transmitters.

### Communication Tower Based Location

A further method for determining location of the client device is based on proximity of the client device to one or more communication sites, such as cellular telephone or network data towers. This information may be determined by which tower the client device is utilizing to maintain a connection. It is also contemplated that signal strength may also indicate distance from the tower such that stronger communication signals between the client device and the tower (antennas) would indicate closer proximity to the tower. Likewise, prior towers with which the client device communicated may also indicate direction and speed. Triangulation between multiple towers may also occur to provide location data. If the location of the tower is know, the location of the client device may be known or inferred.

### Manual User Input

As discussed above, the client device may be configured to allow a user to manually input their location. For example, when the physician arrives at a hospital, the physician may activate software executing on the client device and manually enter the location or select the location as one of two or more pre-stored locations. This provides the physician greater flexibility and privacy as part of the location tracking. In addition, the location may be determined based on the user input into the client device when the user is using the client device to do work. If the physician is updating the client device with medical records or billing code, then it can be deduced that the physician is in the hospital or other known location.

### Schedule Based Location Tracking

Another means for location tracking is to estimate or determine location based on a known or estimated schedule of a physician. It is contemplated that over time a particular physicians schedule may not vary. As such, in the morning the physician may be in his office, during lunch, the physician may prefer to not be tracked and then in the afternoon the physician is always visiting a particular hospital. From this set schedule which is input into the client device, the location of the physician may be determined or estimated.

### Combination of One or More Location Tracking

Any two or more of the above-referenced tracking methods may be combined to perform more accurate and complete location tracking. For example, GPS may be utilized while the client device is located in an automobile or while walking outside, and then when the client device logs into a computer network, the location of the network may replace or supplement the GPS data. This in combination with the manual input from the user or a known schedule allows for accurate location tracking.

### Update Rate

It is also contemplated that the rate at which the client device provides updates to the server may be modified and adjusted based on one or more factors. This reduces network traffic and bandwidth consumption by the mobile device. This also reduces power consumption of the client device leading to longer battery run times. In one method of operation, the rate of update, meaning the rate at which client device obtains or calculates location information, is adjusted based on one or more of the following: the speed of travel of the client device, the location of the client device, the time of day, the set schedule of the physician or other user of the client device, the network connection used by the client device, and the activity being used on the client device. By way of example and not limitation, during period when the client device is not moving at a high rate of speed or the rate of location change is low, then updates may be made less often since the location will change slowly. If the client device is not near a geofenced area, the rate of update may be reduced. If the period of time is at lunch or at night, the rate of update may be reduced. If the location of the client device is such that the user will or typically stays at this location for a long or certain period of time, the rate of location update may be increased. If the schedule of the use of the client device is set for the user to stay at the same location for a long time, then the rate of update may be reduced. If the client device is being used to enter billing codes are access patient information, the rate of update may be reduced. If the client device is connected to a WIFI network the rate of update may be reduced. Other control features are contemplated.

Returning now to FIG. 5, a client device 526 may be located in an automobile 524 and tracked as the client device moves from one location to another. The location data is periodically sent back to the communication system 104 and a database updated or refreshed. The location data may be transmitted through one or more cellular towers 530 via a communication or data network.

### Geofencing

Certain locations may be geofenced such that devices within the fence 534 are considered as being within that location and that location is defined as a single location or group of locations. The location may comprise any facility, but in this embodiment the location comprises a hospital 508. By defining the fence 534 around the hospital, any client device is defined as being at that location. A physician may drive into the location in an automobile 512 with the client device and hence cross the fence and thereby be at that location until the client device leaves the fenced location.

In this manner, the entire location may be defined as within a single boundary and that boundary may be defined using GPS or other type location data to comprise the geofence. If for example a restaurant 520 was located nearby, but outside of the fence 534, then client devices at the restaurant would not be considered at the location 508. This provides the preferred level of resolution. In certain configurations, GPS data may be made accurate to within 3 meters or less.

Also shown in FIG. 5 is a second hospital or medical office complex 550. In this configuration a monitoring station 554 is provided which may access the communication system 104 including a database stored on the memory devices 112. Using the monitoring station 554, a user may log onto the communication system via the network 116 to access the location of one or more physician client devices. The monitoring station 554 may comprise a screen, user input, and network interface. The monitoring station 554 may communicate via hardwired connection or wirelessly via a wireless computer network or cellular data network 560. Using the monitoring station 554, the person monitoring the location of physician client devices may realize that client devices 558A, 558B and 558C are located at, within, or near the hospital 550.

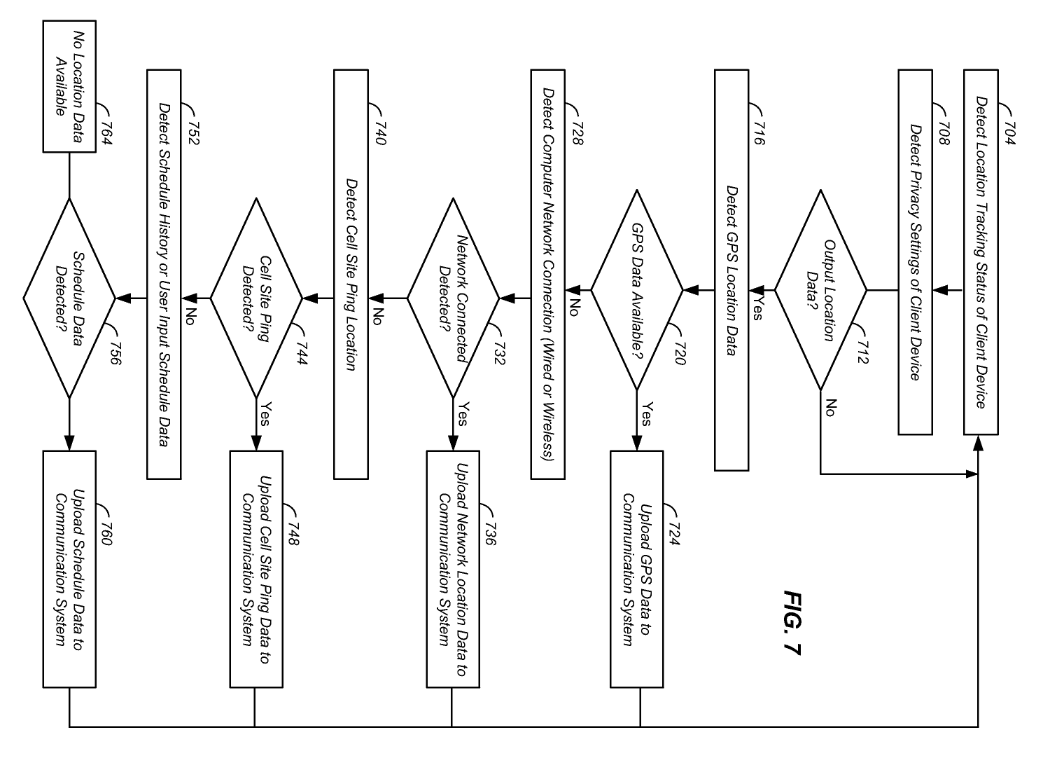

FIG. 6 illustrates an operation flow diagram of an example method of client device operation and system location tracking. This is but one possible method of operation and as such it is contemplated that other methods of operation may occur without departing from the claims that follow. At a step 604 the physician activates the client device. This may comprise turning on the device or executing software, such as machine readable code executing on a processor, on the client device. Then, at a step 608, the client device or physician detects the settings of the communication device software in relation to location tracking. In one embodiment, the physician may enable or disable location tracking to control privacy and location disclosure. It is also contemplated that certain aspects of the location tracking may be enabled or disabled. For example, only computer network connections may be enabled.

At a decision step 612 the operation determines if the client device is outputting location data. If not, the operation returns to step 608 and the operation continues with continual monitoring of the device settings to determine if the software is set to output location data. Alternatively, if at step 612 the device is generating and outputting location data to the communication system, the operation advances to step 616. At step 616 the client device generates location data or authorizes the sending of the location data. Then, at step 620 the system sends the location data to the communication system.

Concurrently, the communication system software executing on the server and memory is activated. This occurs at step 630. Next, at step 634 the system monitors for location data for one or more client devices. It is contemplated that numerous client devices will be periodically providing location data to communication system. The reporting of location data may occur at any interval of time and may be dynamic in response to network traffic and the number of client devices.

At a step 638 the communication system updates the database of location data for the client devices to create an updated database of client device locations on the memory devices. The server may perform this operation. This method of operation continues in this manner and it is contemplated that to gain the benefit of this database of location data, the database is from time to time polled for a download of location information. This occurs at a step 642. The request for location data may arrive from a requestor using a client device or a monitoring station.

To maintain privacy of the location data the location data is restricted to a limited set of individuals (requestors) and further limited in that those requestors granted access are only granted limited access to data that is relevant to their needs. In one embodiment only medical personal may access the location data. In addition, the medical personal may only be able access a limited subset of data, such as the location of physicians in their medical group or within a hospital. Hence, at step 646, the system determines the location data authorization level for the requestor. If the requestor does not have access to any location data, the requestor is notified and access denied. If the requestor is permitted access to the location data, then the authorization level is determined and only the limited subset of data is displayed to the requestor.

At a step 650 the system retrieves the location data subject to the location data authorization level of the requestor and transmits the location data to the requestor over the computer or cellular network. At a step 654 the location data is presented to the requestor. The location data may be presented graphically, such as on a map, or in table format.

To facilitate use and viewing of the location data, the system, at step 658, presents one or more options to the requestor to filter the data. The filters limit or expand the data presented on the screen. The filters may include but are not limited to physicians within a group, physicians within a building or hospital, physicians having a particular specialty, physicians on call at the present time, physicians within a certain geographic distance or time to arrive to hospital, and physicians having privileges at hospital. Then at a step 662, the filtered data is displayed to the requestor.

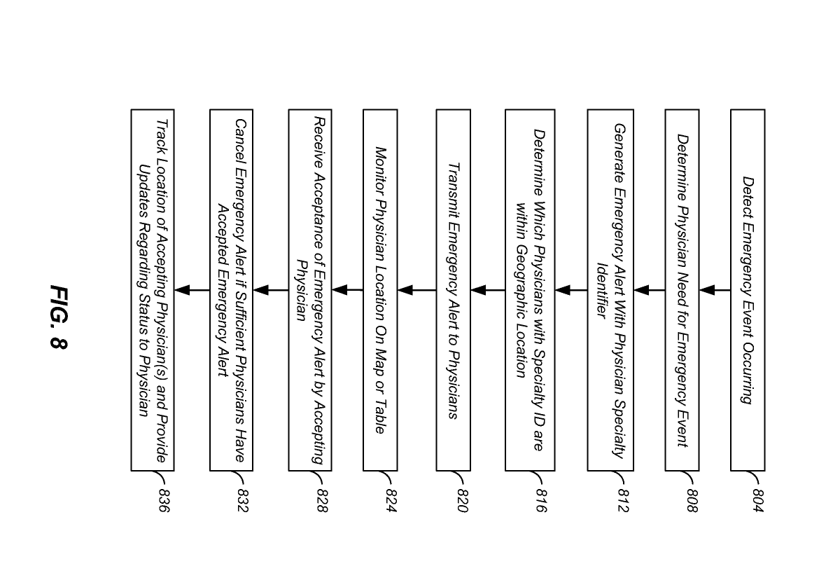

FIG. 7 illustrates an operational flow diagram of an example method of location data generation and upload. This is but one possible method of operation and it is contemplated that other methods of operation may differ including the order of location data analysis and the types of location data which are available and uploaded to the communication system. In addition, it is contemplated that additional privacy protection features may be implemented in connection with this method and some of these potential privacy protection features are discussed below in greater detail.

At a step 704 the software executing on the client device detects the status or settings of the client device software in relation to location tracking. This may comprise determining whether the client device is configured for location tracking, such as whether the GPS or computer network (Wi-Fi) connections are enabled and the settings of the software on the client device. This status information is utilized in subsequent steps as described below. At a step 708 the operation detects the privacy settings of the client device. The privacy settings may be determined by the software on the client device or the overall communication system design. In one embodiment privacy settings include the ability to turn off or selectively enable the location tracking. Privacy settings are discussed below in greater detail.

At a decision step 712 the operation determines, based on steps 704, 708, if the client device is configured for location data tracking and upload. If the client device determines it is not configured for location tracking, the operation return to step 704 and operation of the communication system and client device continues without location tracking. Alternatively, if it is determined at step 712 that the location tracking is enabled, then the operation advances to a step 716.

At a step 716 the client device attempts to detect GPS location data. This step comprises determining if the client device is configured with GPS and whether the GPS is enabled and receiving GPS signals. At decision step 720 the client device determines if GPS data is available. If the GPS data is available, the operation advances to a step 724 and the client device uploads the GPS data to the communication system. With the uploaded data the communication system will update its database of location data for the two or more client devices. This upload occurs as described above and the operation returns to step 704. Although shown as returning to step 704, it is contemplated that the operation may cycle through the other steps of location data acquisition as described below.

Alternatively, if at step 720 the client device determines that the GPS system is not enabled or not receiving GPS data, then the operation advances to step 728. At a step 728 the client device attempts to detect a computer network connection, which may be wireless or wired. This step comprises determining if the client device is configured with a wireless or other network connection capability and whether network data communication is enabled and receiving network signals. At decision step 732 the client device determines if network location data is available and a connection is present. If the network location data is available, the operation advances to a step 736 and the client device uploads the network location data to the communication system. This upload occurs as described above and the operation returns to step 704. Although shown as returning to step 704, it is contemplated that the operation may cycle through the other steps of location data acquisition as described below.

Alternatively, if at step 732 the client device determines that the network communication system is not enabled or not receiving network location data, then the operation advances to step 740. At a step 740 the client device attempts to detect or searches for a cellular site ping location data. As is understood, cellular networks continually ping active mobile communication devices, such as client devices, to assign cellular towers for communication with the mobile communication device. Using this data, the best cellular communication tower or site is selected when routing incoming calls or network data to the mobile communication device.

This type location data may be used for location tracking. A mobile device signal may be picked up by three or more cell towers, enabling “triangulation” to work. From a geometric/mathematical standpoint, if one has the distance to an item from each of three distinct points, it is possible to compute the approximate location of that item in relation to the three reference points. This geometric calculation applies in the case of mobile devices, since the locations of the cell towers which receive the phone's signal are known, and the distance of the phone from each of those antennae towers can be estimated, based upon the lag time between when the tower sends a ping to the phone and receives the answering ping back, based on received signal power, or data regarding signal transmit or receive power included with the signal transmission. In many cases, there may actually be more than three cell towers receiving a phone's signal, allowing for even greater degrees of accuracy. In densely developed, urban areas, the accuracy of cell phone pinpointing is considered to be very high because there are typically more cell towers with their signal coverage areas overlapping. In cases where a user is inside large structures or underground, cell tower triangulation may be the only location pinpointing method since GPS signal may not be available.

For many cell tower networks, the pinpointing accuracy may be even greater, since directional antennae may be used on the tower, and thus the direction of the cell phone's signal might be identifiable. With the signal direction plus the distance of the phone from the cell tower, accuracy might be pretty good, even with only two towers.

Step 740 may also comprise determining if the client device is configured for cellular communication and whether cellular site ping detection is enabled. At decision step 744 the client device determines if cellular site ping location data is available and a connection is present. If the cellular site ping location data is available, the operation advances to a step 748 and the client device uploads the cellular site ping location data to the communication system. This upload occurs as described above and the operation returns to step 704. Although shown as returning to step 704, it is contemplated that the operation may cycle through the other steps of location data acquisition as described below.

Alternatively, if at step 744 the client device determines that the cellular site ping location data is not enabled or it is not receiving cellular site ping location data, then the operation advances to step 752. At a step 752 the client device detects or searches for a schedule history or user input schedule data, which may be stored on the memory of the client device, such as physician input schedule data. This type of data is based on the known or predicted schedule of the physician and can be used to determine or estimate the location of the physician. While not as technically accurate as GPS of other type location data, schedule data provides an additional piece of information in the location tracking process. In addition, at certain times the physician may establish that location data not be available or that regardless of location, he is at a set location and hence available. At decision step 756, the client device determines if schedule based location data is available. If the schedule based location data is available, the operation advances to a step 760 and the client device uploads the schedule based location data to the communication system. This upload occurs as described above and the operation returns to step 704. Alternatively, if schedule data is not available at step 756, the operation advances to step 764 and the system does not report to the communication system or upload data to the communication system any location data, or only a limited subset of data is uploaded. For example, the physician may adjust the settings of the client device to allow schedule data and network data to be uploaded, but not GPS location data. It is contemplated that the client device be available for communication but that the location data is not available.

### Privacy Protection Features

As can be appreciated physicians or other users of the communication system may not want their location to be tracked at all times or at all. Hence, the location tracking features can be disabled by a user of the client device. The ability to control the generation and sending of location data from the client device to the server of the communication device is defined herein as the location data control settings. By adjusting the location data control settings, the location tracking features of a client device can be disabled during certain periods of the day, such as at night or lunch, or on the weekends. Likewise, the location tracking may be disabled or enabled when the client devices is at certain locations or near certain locations. For example, if the client device is at the physician's home, or another family member, then it may stop sending location data to the communication system but the client device may still be able to communicate with the communication system. The same settings may also be established for emergency alerts. In addition, certain locations may be geofenced to disable or enable location tracking, such as within a certain radius of a hospital, the physician's house or when the physician is in another city. It is also contemplated that certain physicians may establish their client device in constant location tracking mode. Temporary disable features may also be made available, such as a one touch button to disable tracking for 15 minutes or for combined intervals of 15 minutes, or an hour, such as for lunch.

To further protect privacy, only a limited set of people will have access to the location data and even that limited set of people will have limited access to only certain physician location data. For example, only senior nurses or certain physicians within a hospital may be granted access to location data, and the location data for those senior nurses or physicians may only be accessed within the hospital and only show physician which are within the geofenced location defined as the hospital. Once a physician leaves the hospital, that physician can no longer be tracked by the senior nurse. Likewise, once the senior nurse or physician leaves the hospital, then the may not longer be able to track physician locations. Hence, tracking may occur to view the resources available within a geographic region or location, or be limited or filtered in any of the following ways: based on time of day or day of the week, limited to certain computers (monitoring stations), based on access codes or passwords, based on physicians within a medical group or company, based on physicians who are on-call, based on physicians having certain specialties, based on physicians who accept certain insurance or payment forms; based on physicians with certain credentials or fee structures, or hospital privileges.

It is also contemplated that the location data sent to the servers may not have any physician identifying information associated or sent therewith. Therefore, any party intercepting the location data will not have an ability to determine which physician is associated with the location data. Instead, a code may be associated with the client device, location data, or physician and only the communication system would know the code and hence be able to associate the code with a physician.

To enable tracking on certain computers, the computer may be equipped with internal hardware that enables that computer to communication with the communication system for location tracking purposes. The computer, such as a monitoring station, may have a software key that is installed only on that particular computer or only compatible with that computer's internal identifying codes.

### Emergency Alert Function

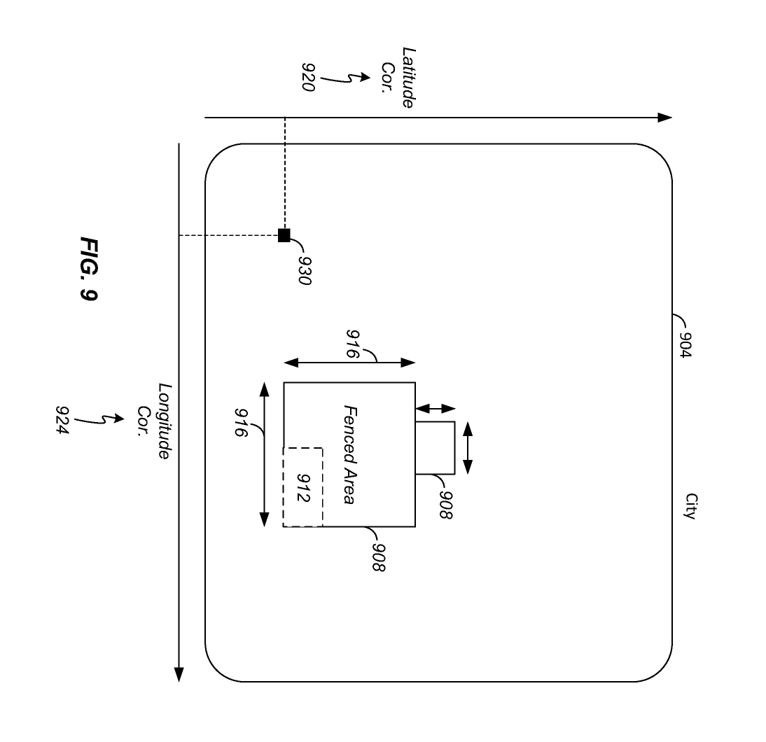

Also disclosed herein is a method for responding to an emergency by generating an emergency alert and request for a responding physician. FIG. 8 illustrates an example method of establishing an emergency alert and request for a responding physician. This is but one possible method of operation of this type process. This method is presented in contemplation of any type patient emergency which requires physician assistance when the required physician is not present with the patient. For example, if a patient is having a heart attack or needs surgery, a specialist physician may be required to meet the needs of the patient. However, the specialist physician may not be physically present with the patient so the specialist physician must be located and requested to come to the patient to provide the required medical care.

This exemplary method begins at a step 804 when the emergency event is detected. Detection of the emergency event may occur by any party, such as a physician, nurse, or user of a monitoring station. Then, at a step 808 the emergency event and patient are evaluated to determine the need for a physician and which specialties are required to treat the patient. One or more specialist physician may be required and different levels of emergency may be established. Different levels of alerts are described as alert levels. In some instances the patient may need the specialist physician immediately, or in other instances, the patient may need treatment within 30 minutes.

At a step 812 the user generates the emergency alert with the physician specialty identifier. In one embodiment only a limited subset of users of the communication system have the capability to create an emergency alert. Creation of the emergency alert may comprise executing software on a monitoring station or client device and entering one or more of the following types of information: the type of specialist which is required, the location of the patient in need of care, the type of emergency with information regarding the patent, and the maximum time frame for response.

After identifying to the communication system the types and number of physicians required to respond to the emergency, the operation advances to a step 816 and the communication system determines which physicians with the identified specialties are within a particular geographic location or able to respond. This may be presented in table form or graphically on a map. If the communication system reveals that specialty physicians are capable of being notified of the emergency with an emergency alert, the operation advances to step 820 and the communication system sends out an emergency alert to the physicians having client devices. In one embodiment all physicians receive the alert while in other embodiments, only physician on call or within a particular geographic location, such as at or near a hospital, receive the emergency alert. As a result of sending the emergency alert, it is contemplated the one or more physicians will receive the emergency alert.

At a step 824, the party generating the emergency alert monitors the physician locations on a map or table and awaits a response. After a short period of time one or more physicians will accept the emergency alert. In the event no one accepts the emergency alert, prior art methods of locating and requesting a physician can be implemented or the emergency alert may be continually sent to client devices until a physician accepts.

A physician accepts the emergency alert in any way understood in the art such as typing or touching an accept button on the screen of the client device or typing in an acceptance code to the client device. This physician is now one or one or more responding physicians. Then, at step 828, the partying generating the emergency alert, such as a party at a monitoring station, will receive the acceptance of the emergency alert by the responding physician and this will display on the monitoring station (computer) screen). It is contemplated that more than one physician may respond to provide redundancy of response in the event of traffic, multiple emergencies, or other contingencies.

At a step 832 the communication system or the party generating the emergency alert may cancel or terminate further sending of the emergency alert so that no other physician need respond. This may occur if sufficient responding physicians have accepted the emergency alert, if the alert was generated and sent in error, or if the patient no longer requires the specialist. The responding physician may or may not be notified depending on the reason for cancelling the alert.

At this time, the physicians are traveling to the location of the patient and this may comprise walking through the hospital or driving to the hospital or other location. The emergency alerts do not have to originate from a hospital but could occur at any location. At a step 836 the monitoring station may receive continual location updates from of the client device for each responding physician and this location data, with optional estimated time of arrival, may be presented on the monitoring station. This data may be used to assist in patient care and prepare the patient for the specialist or to move the patient to surgery at the proper time. Likewise, the responding physician may also receive patient information as they are traveling to the patient to prepare them for the emergency. The patient information provided to the responding physician may include but is not limited to age, sex, weight, blood pressure, heart rate, medications, treatments presented to patient by other physicians/nurses, medical history, or any other useful patient information. As a result, when the physician arrives at the emergency, the physician will be more prepared for the emergency.

### Supplemental Features

In addition to the features described above, the location data may be used for numerous other beneficial features. One such use is for social purpose such that a first physician may access location information to have lunch with a second physician or meet with that second physician when in close proximity to that second physician. In addition, the location data may be used to improve efficient by proposing methods for the physicians to reduce travel time or having a second physician meet with a patient instead of having the first physician drive to that particular hospital for the consult or hospital release. It is also contemplated that the system may interface with Facebook®, Twitter®, or any other social media website or network service.

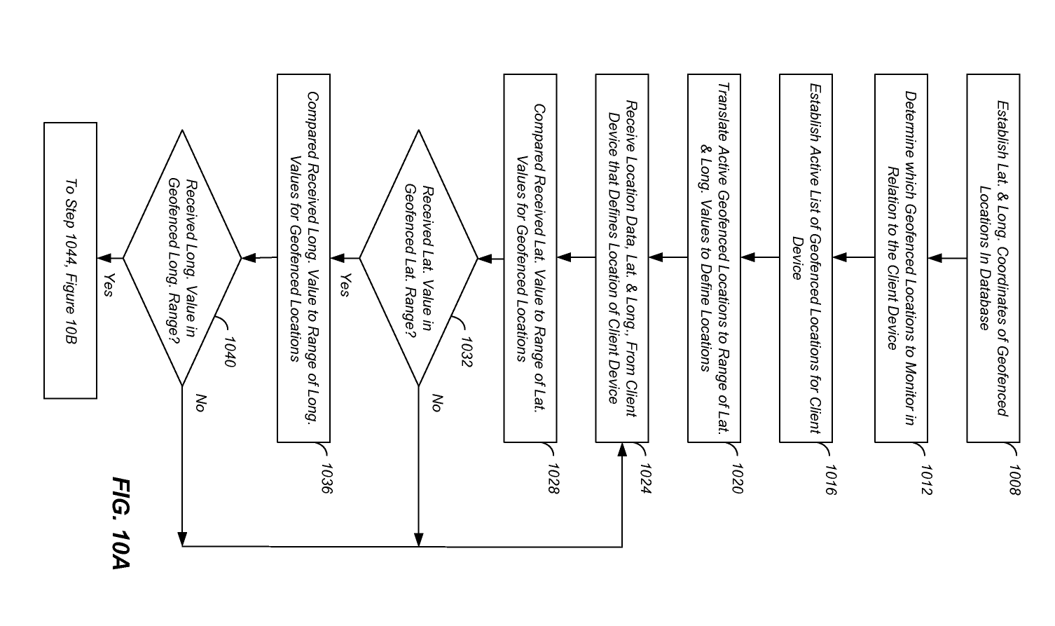

FIG. 9 illustrates an exemplary latitude and longitude map for a geofenced location. FIG. 9 is provided for purposes of discussion. It is contemplated that one of ordinary skill in the art may arrive at other methods of geofencing a location which do not depart from the claims that follow. In this embodiment, a location, such as a city is defined by the space 904. Within this space is a geofenced location 908. Within the geofenced location 908 is an excluded area 912.

The city area 904 or just the geofenced location 908 may be mapped based on latitude coordinates 920 longitude coordinates 924. These coordinates 920, 924 comprise values which define locations within the area 904. These coordinates may be considered as being mapped over the area 904. As the client device (not shown) moves about the area 904, it may report coordinates to the server. For example, if the client device is at location 930, the coordinates would be reported as having corresponding latitude and longitude coordinates. If the client device moved to within a fenced area 908, the coordinates of the client device could be compared to the range of coordinate values 916 defining the fenced area. If the reported coordinates for the client device fall within the coordinate range 916 for the fenced area, then the client device is reported as being within the fenced area. The system may also require that the client device report as being within the fenced area for a certain period of time before the system, such as the server, reports the client device as at or within the fenced area.

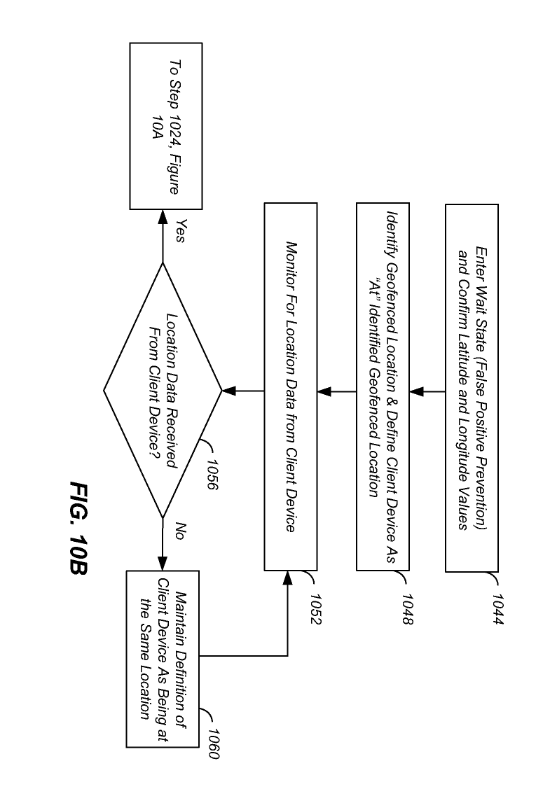

FIG. 10 illustrates an example method of geofence location analysis to determine if a client device is at a geofenced location. This is but one possible method of geofencing. In this example embodiment the operation may establish the latitude and longitude coordinates of geofenced location in the database. This may occur by walking the perimeter of the location while in geofence mode to record the coordinates or these coordinates may be entered manual by an administrator. This process will only occur once at system set-up. The database may be at the server.

At a step 1012 the operation determines which geofenced location(s) to monitor for a particular client device. Although it is possible, it is contemplated that not all client devices will be monitored for location in relation to every geofenced location. At a step 1016, the system establishes an active list of geofenced location for the particular client device. This list may include only the geofenced locations within a particular city or hospitals at which the physician has privileges. This active list may comprise the list of geofenced locations against which a particular the client device is monitored.

At a step 1020 the operation translates the active geofenced location(s) to a range of latitude and longitude coordinates or values which define the location(s). For example, the latitude may range between values Y1 and Y2 while the longitude may range between X1 and X2. The location of the client device, which may be defined as a latitude and longitude values may be compared to or mapped against this range of values. In other embodiments, other methods of tracking or comparison may be used.

At a step 1024 the system, such as the server or other location tracking system, receives location data from a client device. The location data may be in any format including latitude and longitude values. Then the operation compares the received location data of the client device to a latitude and longitude range for the geofenced location. This occurs at a step 1028.

Then, at a decision step 1032, the operation determines if the received latitude value for the client device is within the geofenced latitude range. If it is not, then the client device is not within the geofenced location and the operation returns to step 1024. If either of the latitude and longitude values do not fall within the coordinate range of the geofenced location, then the client device is not at or within the geofenced location.

Alternatively, if at decision step 1032 the comparison determines that the latitude value is within the latitude range for the geofenced location then the operation advances to a step 1036. At step 1036, the operation compares the received longitude value to the range of longitude values that define the geofenced location. At a decision step 1040 the system determines if the received longitude value defining the location of the client device is within the range of longitude values that define the geofenced location. If not, the operation returns to step 1024.

Alternatively, if the received longitude value for the client device is within the range of longitude values that define the geofenced location then the operation advances to step 1044. In this embodiment step 1044 is an optional wait state or location confirmation. This may occur to prevent or reduce the likelihood of false positives. For example, if the client device is just passing by, such as the physician is driving by a geofenced location, then a wait period with a re-analysis confirmation may prevent a false positive.

At a step 1048 the system identifies the geofenced location and defines the client device as being at or within that identified geofenced location. This data may be provided to other user of the physician location system to aid in location tracking. This process may be just one routine that the system uses to track physician location.

At a step 1052, the system monitors for additional location data from the client device. At a decision step 1056 the system determines if additional location data is received from the client device. If additional location data is not received, then the system advances to step 1060 and the system maintains the location of the client device as being as the same location. It is assumed that the client device has not left the geofenced location if additional location data is not received to establish a change in location. If additional location data is received at step 1056 the operation returns to step 1024.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A medical communication system configured to track a location of one or more physicians, the system comprising:
one or more client devices comprising a display, memory containing machine readable code, and a processor configured to execute the machine readable code, the machine readable code configured to:
accept location data control settings from a physician, wherein the location data control settings determine if the client device transmits location data;
activate or deactivate generation of location data according to the location data control settings;
responsive to the location data control settings, transmitting location data to a server, the location data providing at least one aspect of location information of the client device;
one or more servers comprising one or more memory devices storing machine readable code and a processor configured to execute machine readable code, the machine readable code configured to:
receive the location data from two or more client devices;
store the location data in one or more memory devices, the location information indicating at least one aspect of location of the two or more client devices; and
associate the location information with a physician.

2. The system of claim 1, wherein the machine readable code executing on the processor of the server is further configured to:
receive a request for one or more physician locations from a monitoring station;
processing the request by comparing the request to the location data in the one or more memory devices;
identifying location data that meets the request for physician location;
transmitting the identified location data to the monitoring station

3. The system of claim 2, further comprising authenticating the monitoring station.

4. The system of claim 3, further comprising processing the location data to relate the location data to a map or a location of a requestor of the location data.

5. The system of claim 1, wherein the machine readable code executing on the processor of the server is further configured to associate the location data from a client device with a physician using a code.

6. The system of claim 1, wherein the location data control settings comprise settings on the client device which limit location data from being send to the server based on one or more of the following factors: time of day, day of the week, location of the client device, and physician settings in the client device software.

7. A method for requesting physician assistance in response to a medical emergency by a patient comprising:
evaluating the medical emergency to determine physician specialists required to provide treatment to the patient having the medical emergency;
accessing a monitoring station and entering the physician specialists required to provide treatment to the patient;
sending emergency alert through a communication system to one or more client devices having specialist settings which match the physician specialist required to provide treatment to the patient;
receiving one or more acceptances from one or more responding physician client devices in response to the emergency alert;
responsive to receiving one or more acceptances, sending a cancellation of the emergency alert to one or more non-responding physician client devices.

8. The method of claim 7, further comprising monitoring a location of one or more responding physician client devices.

9. The method of claim 8, wherein the location is presented graphically on a map of a display screen.

10. The method of claim 7, further comprising viewing, on the monitoring station, the physician specialists required to provide treatment to the patient which are within a predetermine geographic location.

11. The method of claim 7, wherein the monitoring station comprises a personal computer.

12. The method of claim 7, further comprising inputting information regarding the medical emergency to the monitoring station and sending the information regarding the medical emergency to the one or more responding physicians.

13. A method for determining which physicians are within a geographic region to be performed by a requestor, the method comprising:
activating machine readable code at a physician client device or a monitoring station;
sending a request for physician location data from a requestor at the client device or the monitoring station to a database storing location data indicating the location of one or more physician client devices;
responsive to the request for physician location data receiving physician location data subject to one or more limitations on location data access from the database;
viewing the physician location data on the client device or the monitoring station to determine which physicians are within the geographic region.

14. The method of claim 13, wherein the geographic region comprises a hospital.

15. The method of claim 13, wherein the geographic region comprises a geofenced area and only location data from physician client devices which are within the geofenced area are received by the requestor.

16. The method of claim 14, wherein the physician location data only indicates whether the physician client device is within the geofenced area.

17. The method of claim 13, wherein the location data consists of data generated from one or more of the following types of data: global positioning data, computer network data, cellular site data, physician entered location data and schedule data.

18. The method of claim 13, further comprising sending a request for a consult to a physician located within the geographic area to facilitate discharge of a patent from a hospital.

19. The method of claim 13, further comprising entering one or more filter settings to limit the location data which is presented to the requestor.

20. The method of claim 13, further comprising qualifying the requestor using the machine readable code before the requestor is allowed to access location data.

21. The method of claim 13, further comprising sending a message to one of the one or more physicians which are within the geographic region.
